(19) United States
(12) Patent Application Publication
(10) Pub. No.: US 2014/0144514 A1
(43) Pub. Date: May 29, 2014

(54) DISPENSING AND METERING SYSTEM, IN PARTICULAR OF SUBSTANCES IN MICROFLUIDIC SYSTEMS, AND ALSO METHOD AND CARTRIDGE HAVING THE DISPENSING AND METERING SYSTEM

(71) Applicant: Robert Bosch GmbH, Stuttgart (DE)

(72) Inventors: Martina Daub, Weissach (DE); Juergen Steigert, Stuttgart (DE); Melanie Hoehl, Ditzingen (DE)

(73) Assignee: Robert Bosch GmbH, Stuttgart (DE)

(21) Appl. No.: 14/091,523

(22) Filed: Nov. 27, 2013

(30) Foreign Application Priority Data
Nov. 29, 2012 (DE) 10 2012 221 848.3

(51) Int. Cl. B01L 3/00

(52) U.S. Cl. CPC B01L 3/52
USPC 137/1; 422/527; 422/504

(57) ABSTRACT

A dispensing and metering system, in particular of substances in microfluidic systems, includes a fluid and a stored substance. In an initial configuration, the stored substance is separated from the fluid by a separation element. The stored substance is dispensed to the fluid by actuation upon the separation element.

This application claims priority under 35 U.S.C. §119 to patent application no. DE 10 2012 221 848.3 filed on Nov. 29, 2012 in Germany, the disclosure of which is incorporated herein by reference in its entirety.

### BACKGROUND

The basis for carrying out biochemical processes is, in particular, the handling of liquids. Typically, this handling is carried out manually with aids, such as pipettes, reaction vessels, active probe surfaces or laboratory instruments. These processes are already partially automated by means of pipetting robots or special instruments.

Lab-on-a-chip systems (also designated as vest pocket laboratory or chip laboratory) accommodate the entire functionality of a macroscopic laboratory on a plastic substrate only the size of a credit card. Lab-on-a-chip systems are typically composed of two main components. A test carrier contains structures and mechanisms for implementing the basic fluidic operations (for example, mixers), which may be composed of passive components, such as ducts, reaction chambers and preceding reagents, or else of active components, such as valves or pumps. The second main component comprises actuation, detection and control units. Such systems make it possible to carry out biochemical processes in a fully automated way.

US 2005/0191708 A1 shows a microfluidic system in which small liquid volumes can be moved or mixed by virtue of materials which are heated by means of microwaves.

### SUMMARY

The dispensing and metering system, the cartridge, and the method disclosed herein have, as compared with conventional solutions, the advantage that stored substances (in any state of aggregation) can be released in a directed way by actuation or by contact with further substances in a fluid, the stored substance being located in the fluid or adjacently to the fluid in an initial configuration of the dispensing and metering system, and a separation element preventing the intermixing of stored substance and fluid until actuation upon the separation element occurs.

The present metering and dispensing system can advantageously be used for the storage of substances, for their directed release and at the same time as a metering, dispensing and modeling system. In general terms, the present metering and dispensing system is suitable especially for the directed matching of the reaction kinetics of the fluid with the stored substance dispensed, the reaction kinetics being controllable primarily by the choice of material for the separation element. Owing to the choice of material for the separation element and directed setting of its properties (for example, surface quality, topography, density and geometry), and to the arrangement of the separation element (for example, spatially or geometrically) and/or due to a change in external actuation, the present metering and dispensing system can advantageously be activated or its dispensing behavior modified in a directed way, independently of instrument activation methods, such as, for example, the rotational speed of the centrifuge or the utilization of pneumatic valves.

The present metering and dispensing system may, for example, be employed for chemical reactions, biological reactions (in the manner of reagent storage, kinetic assays, for example fluorescence, immuno or enzyme steps) and other processes (enzyme or reagent for kinetic enzymatic reaction in a cartridge with a “ballpoint mechanism”, as it is known).

Furthermore, in the present dispensing and metering system, the hitherto necessary complicated welding, sealing or thermal or ultrasonic bonding of chambers for specific reagents (by, for example, a metal foil) may advantageously be dispensed with. Thus, the present metering and dispensing system can be implemented cost-effectively in a technically simple way and can easily be integrated into existing devices and instruments.

Actuation is to be understood to mean any type of directed and/or predetermined action upon the separation element which ensures that the stored substance is dispensed to the liquid. In principle, actuation may also take place as a result of the contact of the separation element with the stored substance and/or the fluid. Preferably, however, actuation upon the separation element takes place from outside the dispensing and metering system (for example, in the manner of heat or radiation or contact with a substance).

In the present context, “fluid” and “stored substance” mean a liquid, a gas, a particle (or a plurality of particles) or a solid material.

Advantageous refinements of the disclosure may be gathered from the subclaims.

According to one refinement of the dispensing and metering system according to the disclosure, actuation comprises physical or chemical stimulation of the separation element. Examples given of physical stimulation may be an (external) force, centrifugal force, (hydrostatic) pressure or electrical energy. Examples given for chemical stimulation may be the pH value, solubility, surface size and temperature of the stored substance, separation element or fluid. Alternatively and/or additionally, actuation may also comprise the contact of the stored substance with the fluid.

According to a further refinement of the dispensing and metering system according to the disclosure, the dispensing of the stored substance to the fluid after the actuation of the separation element takes place in a continuously metered manner, discretely, with a time delay or in multiple stages over a predefined period of time. Continuously metered dispensing is intended to describe dispensing at an essentially constant dispensing rate of the stored substance over the predefined period of time. Discrete dispensing is intended to describe essentially once-only dispensing of the stored substance over the predefined period of time. Time-delayed dispensing is intended to describe dispensing of the stored substance after a predetermined delay time as a follow-up to the actuation of the separation element over the predefined period of time. The selected dispensing rate for time-delayed dispensing may be constant or variable as a function of the material and of the properties of the separation element. Multiple-stage dispensing is intended to describe multiple dispensing of the stored substance over the predefined period of time. The selected dispensing rate for multiple-stage dispensing may again be constant or variable as a function of the material and of the properties of the separation element.

According to a further refinement of the dispensing and metering system according to the disclosure, the separation element is composed of a bioprocess-compatible material. What may be considered as material for the separation element is, in principle, all materials which become unstable as a result of contact with substances and/or by actuation. These include, for example, (special) polymers, wax (for example, paraffins), materials for the production of drug capsules (for example, gelatine, decomposable polymers, sugar, sugar derivatives). A bioprocess-compatible material is distinguished in that it is degradable and harmless to health, and there is no appreciable participation of the material in a (chemical) reaction of stored substance and fluid. Interactions of the separation element or of the predetermined breaking point with the fluid and with other substances used in the dispensing and metering system can thereby be minimized or avoided.

According to a further refinement of the dispensing and metering system according to the disclosure, the separation element completely surrounds the stored substance in the initial configuration. Thus, for example, the stored substance can be enclosed on all sides in a capsule. The capsule may have a round, oval or angular casing or may have any other form. The capsule may be formed from the material of the separation element completely or else only partially.

According to a further refinement of the dispensing and metering system according to the disclosure, the separation element partially surrounds the stored substance in the initial configuration. In a dispensing and metering system of this type, the stored substance is surrounded, for example, on only one side by the separation element. This may be a configuration in which a duct or a chamber open on one side receives in each case the fluid and the stored substance, the fluid and the stored substance being separated from one another in the initial configuration by the intermediate separation element. In addition to this, the stored substance may also be surrounded by the separation element on more than one side, as is the case, for example, in an L-shaped or T-shaped branch of a duct or pipe.

According to a further refinement of the dispensing and metering system according to the disclosure, the actuation of the separation element ensures permeability of the separation element for the stored substance. In this case, actuation causes a directed modification in the material make-up and/or in the surface of the separation element, so that the stored substance can pass through the separation element and subsequently comes into contact with the fluid. Thus, permeability of the separation element can be achieved as a function of selected actuation parameters (for example, temperature, pressure, pH value, etc.). Alternatively, the actuation of the separation element can ensure an essentially complete dissolution or destruction of the separation element, in which case the stored substance is dispensed only once and completely to the fluid.

According to a further refinement of the dispensing and metering system according to the disclosure, the separation element has a multilayer make-up. In this case, for example, an outer layer may be formed in such a way that dispensing of the stored substance is prevented until the actuation of the separation element occurs, the outer layer being, for example, essentially completely or at least partially broken down or destroyed as a result of actuation. A layer lying underneath may be formed in such a way that it remains essentially unchanged after the actuation of the separation element, said actuation being designed in such a way that it implements the desired dispensing behavior of the stored substance to the fluid over time.

According to a further refinement of the dispensing and metering system according to the disclosure, the separation element has a first material and a second material and, in the initial configuration, both the first material and the second material are in contact with the fluid. The present dispensing and metering system can thus be formed, for example, by the mixing or alternating arrangement of the at least two materials for the separation element or by the connection of the two materials, while the two materials may have different material properties (for example, different strength, variability in stability upon contact with the fluid (for example, solubility), different surface size (for example, grain size), dependence upon actuation parameters (for example, temperature dependence, pressure dependence, etc.)). The two materials for the separation element may be formed from different stock, but they may also be formed by one and the same stock which, however, has in each case different properties in compliance with the intended use of the dispensing and metering system. A combination of a multilayer make-up and of a make-up by means of a plurality of materials is also possible for the separation element.

According to a further refinement of the dispensing and metering system according to the disclosure, the separation element has a predetermined breaking point. In this case, the predetermined breaking point is preferably composed of a bioprocess-compatible material, such as, for example, sugar or gelatine. Interactions of the separation element or of the predetermined breaking point with the fluid and with other substances used in the dispensing and metering system can thereby be minimized or avoided. In addition to this, the material for the predetermined breaking point may be selected in such a way that it is, for example, temperature- and/or liquid-dependent.

In a dispensing and metering arrangement, at least two metering and dispensing systems according to the disclosure may also be nested, placed one above the other, arranged in cascade form and connected in parallel and/or in series.

According to a further embodiment, a cartridge is claimed, having
a dispensing and metering system,
a housing of the cartridge,
a drum which has at least one chamber,
the dispensing and metering system being arranged inside the drum.

The present cartridge can advantageously be used for releasing a stored substance into the fluid, such as is necessary, for example, in the medical analysis and/or diagnosis of a sample material. Thus, in this case, for example, proteinase K can be released in the lysis step over a specific period of time or for incubation, for example in the lysis step, over a defined period of time.

According to a further alternative embodiment, a method for producing a component is claimed, which has the following steps:
provision of a dispensing and metering system according to the disclosure,
production of a component by dispensing the stored substance to the fluid, the component being formed from the stored substance dispensed and from the fluid after the actuation of the separation element.

In the present context, “component” means a liquid, a gas, a solid particle (or a multiplicity of solid particles) or a solid material.

The present method can advantageously be used for the production of substances of all kinds, during the production of which a separation of the stored substance and fluid is first necessary. The present method is therefore suitable, in particular, for the production of chemicals, biological products and medical substances. Depending on the dispensing kinetics of the stored substance, the respective processes (for example, chemical, physical and biological reactions) can be regulated in a directed way. For example, the present dispensing and metering system may also be employed in processes in which, because of low stability, the reaction partners involved can be brought together only shortly before use. These include, for example, the mixing of buffers, enzymes, vitamins and dyes with liquids, although other reaction partners may also be envisaged.

According to a further refinement of the method according to the disclosure for producing a component, the dispensing of the stored substance to the fluid after the actuation of the separation element takes place in a continuously metered manner, discretely, with a time delay or in multiple stages over a predefined period of time. Continuously metered dispensing is intended to describe dispensing at an essentially constant dispensing rate of the stored substance over the predefined period of time. Discrete dispensing is intended to describe essentially once-only dispensing of the stored substance over the predefined period of time. Time-delayed dispensing is intended to describe dispensing of the stored substance after a predetermined delay time as a follow-up to the actuation of the separation element over the predefined period of time. The selected dispensing rate for time-delayed dispensing may be constant or variable as a function of the material and of the properties of the separation element. Multiple-stage dispensing is intended to describe multiple dispensing of the stored substance over the predefined period of time. The selected dispensing rate for multiple-stage dispensing may again be constant or variable as a function of the material and of the properties of the separation element.

### BRIEF DESCRIPTION OF THE DRAWINGS

Exemplary embodiments of the disclosure are illustrated in the figures of the drawings and are explained in more detail in the following description.

In the drawings:

FIG. 1 shows diagrammatically a side view of a dispensing and metering system according to a first exemplary embodiment of the present disclosure;

FIG. 2 shows a top view of a dispensing and metering system according to a second exemplary embodiment of the present disclosure;

FIG. 3 shows a top view of a dispensing and metering system according to a third exemplary embodiment of the present disclosure;

FIGS. 4A-4C show the time sequence of dispensing of a stored substance to a fluid in a dispensing and metering system according to a further exemplary embodiment of the present disclosure;

FIG. 5 shows diagrammatically a view from above of a separation element with a layer structure according to the present disclosure;

FIG. 6 shows diagrammatically a view from above of a separation element composed of different materials in a mixed arrangement according to the present disclosure; and

FIG. 7 shows diagrammatically a cartridge having a dispensing and metering system according to a further exemplary embodiment of the present disclosure.

### DETAILED DESCRIPTION

In the figures, the same reference symbols designate identical or functionally identical elements, unless anything to the contrary is indicated.

FIG. 1 shows diagrammatically a side view of a dispensing and metering system 100 according to a first exemplary embodiment of the present disclosure. The dispensing and metering system 100 has a fluid 10 which is received in a chamber 15 in an initial configuration of the dispensing and metering system 100. In the initial configuration of the dispensing and metering system 100, a stored substance 20 is located within the fluid 10 and is prevented from contact with the fluid 10 by a separation element 30. The separation element 30 surrounds the stored substance 20 completely and is designed in the manner of a capsule which has an ellipse-like form. Dispensing of the stored substance 20 to the fluid 10 takes place by actuation (not illustrated) upon the separation element 30.

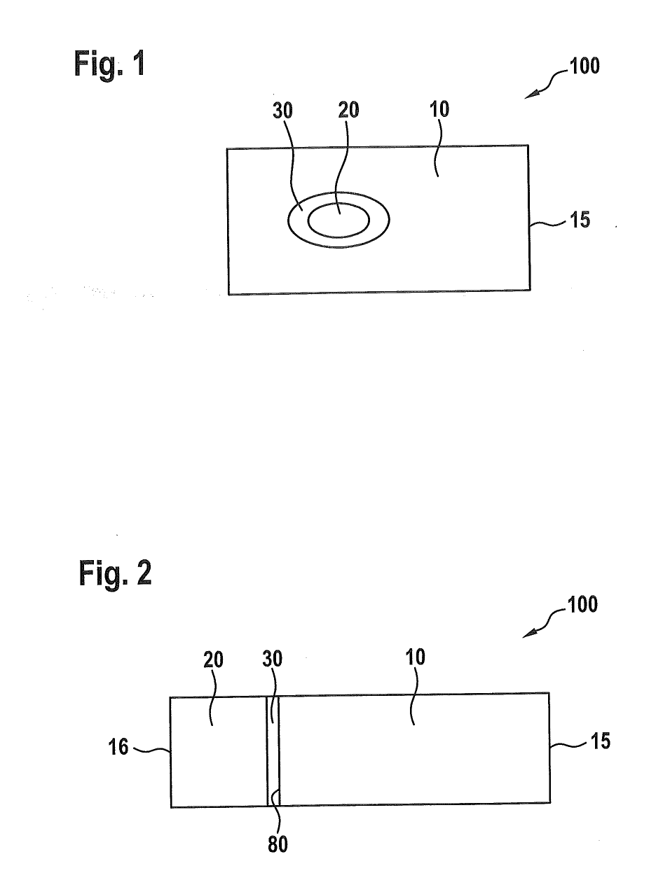

FIG. 2 shows a top view of a dispensing and metering system 100 according to a second exemplary embodiment of the present disclosure. The dispensing and metering system 100 has a fluid 10 which is received in a first chamber 15 in an initial configuration of the dispensing and metering system 100. In the initial configuration of the dispensing and metering system 100, a stored substance 20 is received in a second chamber 16, the first chamber 15 and the second chamber 16 being separated from one another by a separation element 30. In the initial configuration, the separation element 30 prevents contact of the stored substance 20 with the fluid 10. The separation element 30 extends over the entire cross section of the first chamber 15 and is designed in the manner of a membrane.

Furthermore, the separation element 30 has a predetermined breaking point 80 which is provided as a planned breaking point. The predetermined breaking point 80 is formed in the manner of a notch or nick. Dispensing of the stored substance 20 to the fluid 10 takes place by actuation (not illustrated) upon the separation element 30, in particular in the region of the predetermined breaking point 80, with the result that the separation element 30 fails in a directed and predictable way in order thereby to achieve the desired dispensing.

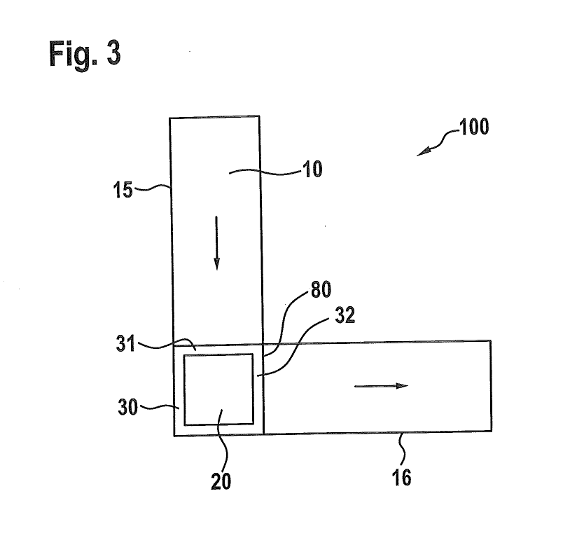

FIG. 3 shows a top view of a dispensing and metering system 100 according to a third exemplary embodiment of the present disclosure. The dispensing and metering system 100 has a fluid 10 which is received in a first chamber 15 in an initial configuration of the dispensing and metering system 100. A second chamber 16 is formed adjacently to the first chamber 15 and is arranged perpendicularly to the first chamber 15. In the initial configuration of the dispensing and metering system 100, a stored substance 20 is received in a region of connection of the first chamber 15 to the second chamber 16, the stored substance 20 being surrounded completely by a separation element 30 which, in the initial configuration of the dispensing and metering system 100, separates the fluid 10 from the stored substance 20. The separation element 30 has a first separation region 31 which, in the initial configuration of the dispensing and metering system 100, separates the fluid 10 from the stored substance 20, extends over the entire cross section of the first chamber 15 and is formed in the manner of a membrane. Moreover, the separation element 30 has a second separation region 32 which, in the initial configuration of the dispensing and metering system 100, extends over the entire cross section of the second chamber 16 and is likewise formed in the manner of a membrane. Furthermore, the separation element 30 has in the region of the second separation region 32 a predetermined breaking point 80 which is provided as a planned breaking point. The predetermined breaking point 80 is formed in the manner of a notch or nick.

Dispensing of the stored substance 20 to the fluid 10 takes place by actuation (not illustrated) upon the separation element 30, in particular first upon the first separation region 31 and subsequently upon the second separation region 32 in the area of the predetermined breaking point 80. The mixture of the stored substance 20 and of the fluid 10 flows into the second chamber 16 after the destruction or actuation of the second separation region 32.

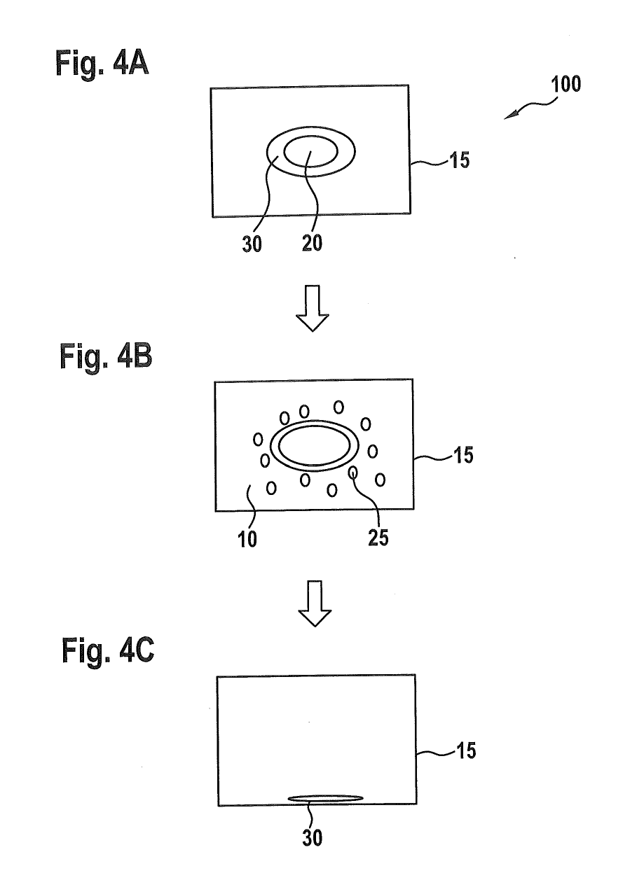

FIGS. 4A-4C show the time sequence of dispensing of a stored substance 20 to a fluid 10 in a dispensing and metering system 100 according to a further exemplary embodiment of the present disclosure. FIG. 4A shows an initial configuration of the dispensing and metering system 100 in which the stored substance 20 is located together with a separation element 30 in a chamber 15. The separation element 30 completely surrounds the stored substance 20 and is designed in the manner of a capsule which has an ellipse-like form. As soon as the separation element 30 comes into contact with the fluid 10, which may be gaseous, solid or liquid, it begins to become permeable and the stored substance 20 is released in the manner of a multiplicity of droplets 25 to the fluid 10, as illustrated in FIG. 4B.

After a predetermined defined time, the entire stored substance 20 has been dispensed to the fluid 10, the chamber 15 then containing both the fluid 10 and the new substance which is formed from the stored substance 20 and from the fluid 10 (see, in this respect, FIG. 4C). The remains of the separation element 30 are still located in the chamber 15. Alternatively to this, the separation element 30 may also decompose or break down completely as a result of actuation.

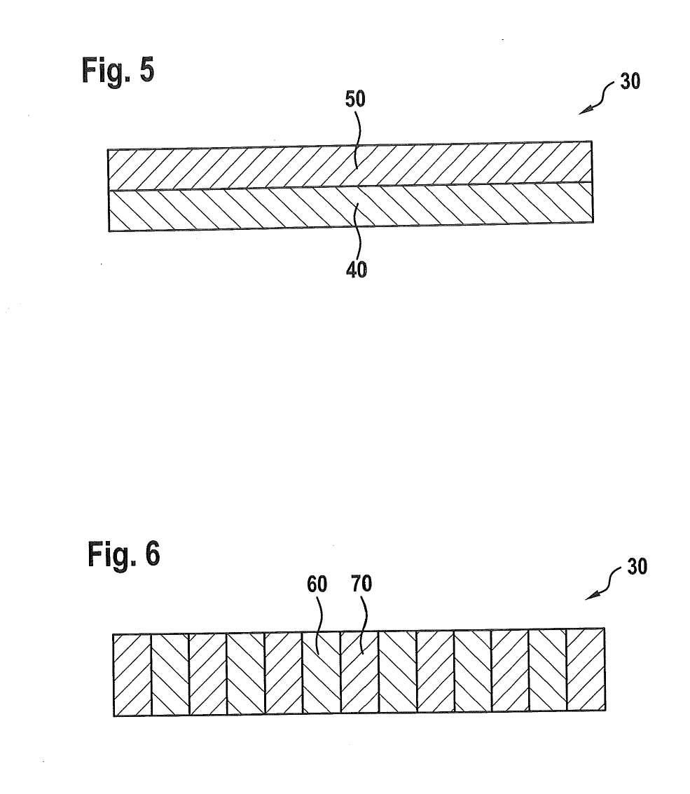

FIG. 5 shows diagrammatically a view from above of a separation element 30 with a layer structure according to the present disclosure. In the initial configuration of the dispensing and metering system 100, the separation element 30 has a first layer 40 which is in contact with a stored substance (not illustrated). The first layer 40 may surround the stored substance completely or partially. Formed adjacently to the first layer 40 is a second layer 50 which is coupled to the first layer 40 and may be in contact with a fluid (not illustrated). The materials of the first layer 40 and of the second layer 50 for the separation element 30 may be formed from different stock, but they may also be formed by one and the same stock which, however, in each case has different properties as a function of the intended use or of the desired dispensing behavior of the dispensing and metering system 100.

FIG. 6 shows diagrammatically a view from above of a separation element 30 composed of different materials 60, 70 in the mixed arrangement according to the present disclosure. The separation element 30 has a first material 60 and a second material 70 and, in the initial configuration of the dispensing and metering system (not illustrated), both the first material 60 and the second material 70 are in contact with a fluid (not illustrated). The present dispensing and metering system can thus be formed, for example, by the mixing or alternating arrangement of the at least two materials 60, 70 for the separation element 30 or by the connection of the two materials 60, 70, while the two materials 60, 70 may have different material properties (for example, different strength, variability in stability upon contact with the fluid (for example, solubility), different surface size (for example, grain size), dependence upon actuation parameters (for example, temperature dependence, pressure dependence, etc.)). The two materials 60, 70 for the separation element 30 may be formed from different stock, but they may also be formed by one and the same stock which, however, has in each case different properties as a function of the intended use of the dispensing and metering system 100.

In a further embodiment (not illustrated), a combination of a multilayer make-up and of a make-up by means of a plurality of materials according to FIG. 5 is also possible for the separation element 30.

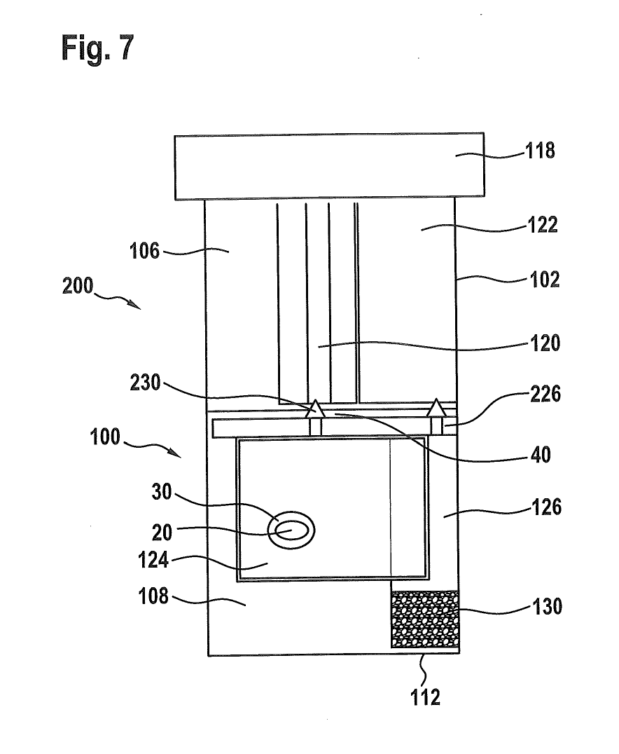

FIG. 7 shows diagrammatically a cartridge 200 having a dispensing and metering system 100 according to a further exemplary embodiment of the present disclosure.

The cartridge 200 comprises a housing 102 in the form of a small tube. For example, the housing 102 may be designed as a 5 to 100 ml, in particular 50 ml, centrifuge tube, as a 1.5 ml or 2 ml Eppendorf tube or alternatively as a microtiter plate (for example, 20 μl per cavity).

A first drum 106 and a second drum 108 are received in the housing 102. The drums 106 and 108, 110 are arranged one behind the other and with their respective mid-axes coaxial with the longitudinal axis of the housing 102.

The housing 102 is designed to be closed at one of its ends 112. The other end, opposite the end 112, of the housing 102 is closed by means of a closure 118. The closure 118 can preferably be removed in order to extract the drums 106 and 108 from the housing 102. Alternatively, the housing 102 may itself also be dismantlable in order to extract the drums 106 and 108.

A respective drum 106, 108 may have one or more chambers. Thus, for example, the drum 106 comprises a plurality of chambers, such as a first chamber 120 for receiving an actuation material and a second chamber 122 for receiving a sample, for example a blood sample, which has been taken from a patient.

The drum 108 following the drum 106 comprises a mixing chamber 124 in which the actuation material from the chamber 120 is mixed with a stored substance 20 of the dispensing and metering system 100. The stored substance 20 is protected from contact with the surroundings by a separation element 30 in the initial configuration of the dispensing and metering system 100, the separation element 30 completely surrounding the stored substance 20. Alternatively, the dispensing and metering system 100 may also be integrated in the first drum 106 or at another location in the cartridge 200. The separation element 30 is actuated here by one or more gaseous, solid or liquid actuation material(s) from the chamber 120. Alternatively, the actuation material may also be delivered via a predetermined breaking point (not illustrated) or other mechanisms (for example, capillary forces, centrifugal forces, valves, etc.). In a further embodiment (not illustrated), the stored substance 20 is delivered, together with the separation element 30, to the actuation material.

Moreover, the drum 108 comprises, for example, a further chamber 126 in which the mixture flows out of the mixing chamber 124 through a solid phase 130. The solid phase 130 may be a gel column, a silica matrix or a filter.

A fluidic connection between the drums 106 and 108 is implemented, using a lancet device 226. The lancet device 226 comprises a plate with a plurality of spikes 230 which are in each case arranged adjacently to an orifice (not illustrated) in the plate. The spikes 230 serve for piercing a respective orifice in the underside of the drum 106 under control by rotational speed, whereupon, in particular, liquid flows out of the corresponding chamber 120, 122 through the orifice into the chambers 124 and/or 126.

To initiate the dispensing and metering system 100, in addition to bringing together the stored substance or substances and actuation material or actuation materials, one or more further actuation step(s) may be necessary (for example, by means of temperature, the setting of a predetermined pH value, centrifugal force, pressure, electrical, etc.). Insofar as a cartridge 200 contains a plurality of dispensing and metering systems, these may also be employed in series, in parallel or in a nested manner.

Although the disclosure has been described in the present context by means of preferred exemplary embodiments, it is in no way restricted to these, but can be modified in many different ways. In particular, it is pointed out that, in the present context “a” does not rule out a multiplicity.

What is claimed is:

1. A dispensing and metering system, comprising:
a fluid;
a stored substance; and
a separation element configured to separate the stored substance from the fluid in an initial configuration, the stored substance being dispensed to the fluid by actuation upon the separation element.

2. The dispensing and metering system according to claim 1, wherein the actuation comprises physical or chemical stimulation of the separation element.

3. The dispensing and metering system according to claim 1, wherein the stored substance is dispensed to the fluid after the actuation of the separation element in a continuously metered manner, discretely, with a time delay, or in multiple stages over a predefined period of time.

4. The dispensing and metering system according to claim 1, wherein the separation element comprises a bioprocess-compatible material.

5. The dispensing and metering system according to claim 1, wherein the separation element completely surrounds the stored substance in the initial configuration.

6. The dispensing and metering system according to claim 1, wherein the separation element partially surrounds the stored substance in the initial configuration.

7. The dispensing and metering system according to claim 1, wherein the actuation of the separation element ensures permeability of the separation element for the stored substance.

8. The dispensing and metering system according to claim 1, wherein the separation element has a multilayer make-up.

9. The dispensing and metering system according to claim 1, wherein the separation element has a first material and a second material and, in the initial configuration, both the first material and the second material are in contact with the fluid.

10. The dispensing and metering system according to claim 1, wherein the separation element has a predetermined breaking point.

11. A cartridge, comprising:
a housing;
a drum having at least one chamber; and
a dispensing and metering system arranged inside the drum, the dispensing and metering system including:
a fluid;
a stored substance; and
a separation element configured to separate the stored substance from the fluid in an initial configuration, the stored substance being dispensed to the fluid by actuation upon the separation element.

12. A method for producing a component, comprising:
producing a component by dispensing a stored substance to a fluid in a dispensing and metering system, the dispensing and metering system including a separation element configured to separate the stored substance from the fluid in an initial configuration, the stored substance being dispensed to the fluid by actuation upon the separation element,
wherein the component is formed from the stored substance dispensed and from the fluid after the actuation of the separation element.

13. The method for producing a component according to claim 11, wherein the stored substance is dispensed to the fluid after the actuation of the separation element in a continuously metered manner, discretely, with a time delay, or in multiple stages over a predefined period of time.

14. The dispensing and metering system according to claim 1, wherein the dispensing and metering system is configured for substances in microfluidic systems.
